(19) United States
(12) Patent Application Publication
(10) Pub. No.: US 2025/0238324 A1
(43) Pub. Date: Jul. 24, 2025

(54) IDENTIFICATION AND REMOVAL OF ISSUE CAUSING FUNCTIONS

(71) Applicant: Dell Products L.P., Round Rock, TX (US)

(72) Inventors: Parminder Singh Sethi, Ludhiana (IN); Veena Ramarao, Bangalore (IN)

(21) Appl. No.: 18/417,753

(22) Filed: Jan. 19, 2024

(51) Int. Cl. G06F 11/14; G06F 9/4401; G06F 11/07

(52) U.S. Cl. CPC G06F 11/1417; G06F 9/4401; G06F 11/0766

(57) ABSTRACT

A method comprises executing a booting operation comprising booting of an operating system of a host device and booting of an operating system of a data processing unit running on the host device, and detecting a failure of at least the booting of the operating system of the data processing unit. Execution of the booting operation is paused in response to the detecting, and data corresponding to the failure is collected. At least one function associated with the data processing unit that is contributing to the failure is identified based on the collected data. A basic input/output system of the host device is provided with access to identifying information for the at least one function. The booting operation is re-executed, wherein the basic input/output system excludes the at least one function from being configured by the operating system of the host device based on the identifying information.

### FIELD

The field relates generally to information processing systems, and more particularly to function management in such information processing systems.

### BACKGROUND

In a virtualized or network hypervisor environment, a host device operating system (OS) and/or application imitates networking services of Layer 2 to Layer 7 of the open systems interconnection (OSI) model. The networking services include, for example switching, routing, providing firewalls, and load balancing. Host device (e.g., server) resources are used for the networking services, which impacts host device performance.

A data processing unit (DPU) such as, for example, a network interface controller (NIC) works on its own operating system, separate from that of a host device operating system. In some situations, host device resource-consuming services are offloaded to DPU, and network services and/or applications run on the DPU operating system, which accelerates system and/or network communications. A DPU can enhance data center networking, security, storage efficiency and flexibility by reducing processing volume of host device resources. However, issues with DPU functions may adversely affect the operation of a host device operating system.

### SUMMARY

Embodiments provide a platform and techniques for function management.

For example, in one embodiment, a method comprises executing a booting operation comprising booting of an operating system of a host device and booting of an operating system of a data processing unit running on the host device, and detecting a failure of at least the booting of the operating system of the data processing unit. Execution of the booting operation is paused in response to the detecting, and data corresponding to the failure is collected. At least one function associated with the data processing unit that is contributing to the failure is identified based at least in part on the collected data. A basic input/output system of the host device is provided with access to identifying information for the at least one function. The booting operation is re-executed, wherein the basic input/output system excludes the at least one function from being configured by the operating system of the host device based at least in part on the identifying information.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system comprising a platform for identifying and removing functions causing operational issues, according to an illustrative embodiment.

FIG. 2A depicts a function identification portion of a boot sequence between a basic input/output system (BIOS) and a baseboard management controller (BMC), according to an illustrative embodiment.

FIG. 2B depicts a continuation of the boot sequence between BIOS and BMC following the function identification portion, according to an illustrative embodiment.

FIG. 3 depicts an operational flow for issue causing function identification and removal in connection with a booting sequence, according to an illustrative embodiment.

FIG. 4 depicts a process for identifying and removing functions causing operational issues, according to an illustrative embodiment.

FIGS. 5 and 6 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

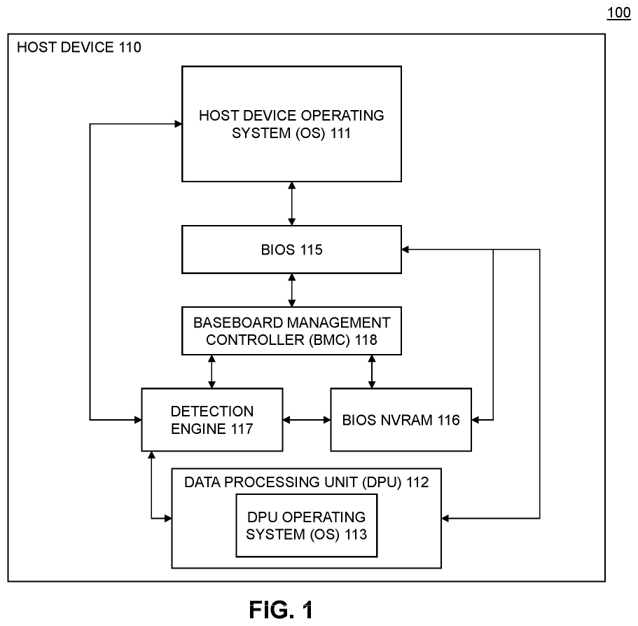

FIG. 1 depicts an information processing system 100 comprising a host device 110 including a host device operating system (OS) 111 and a data processing unit (DPU) 112. The DPU 112 includes its own operating system (DPU operating system (OS) 113), which is different from the host device operating system 111. In illustrative embodiments, the DPU 112 comprises a network interface controller (NIC), and more particularly, a SmartNIC with advanced reduced instruction set computer (RISC) machine (ARM) central processing units (CPUs). The DPU operating system (OS) 113 comprises, for example, ESXi. The host device operating system 111 comprises, for example, Windows, Linux or other type of operating system different from the DPU operating system 113.

The host device 110 further includes a basic input/output system (BIOS) 115, a BIOS non-volatile random-access memory (NVRAM) 116 or other persistent storage of the BIOS 115, a detection engine 117 and a baseboard management controller (BMC) 118. In a non-limiting illustrative example, the BIOS 115 can be in the form of firmware and/or software which includes a program that starts a computer system after it is powered on, and manages data flow between a computer's operating system (e.g., host device operating system 111) and attached devices, such as, for example, the DPU 112, a hard disk, video adapter, keyboard, mouse, printer, etc. The BIOS 115 can be embedded on a memory chip on a system board or motherboard of the host device 110, and function as an interface between hardware of the host device 110 and the host device operating system 111.

The BMC 118 comprises a specialized processor that monitors the physical state of the host device 110 or other hardware. The BMC 118 may use one or more sensors (not shown) to measure parameters such as, for example, temperature, humidity, power-supply voltage, fan speeds, communications parameters and functions of the host device operating system 111, DPU operating system 113 and other operating systems associated with the host device 110. The BMC 118 can be part of an intelligent platform management interface (IPMI) and may be a component of the motherboard or main circuit board of the host device 110.

A non-limiting example of a BMC 118 is a remote access controller (RAC) such as, for example, an integrated Dell® RAC (IDRAC). An iDRAC allows information technology (IT) administrators to monitor, manage, update, troubleshoot, and remediate the host device 110 (e.g., server) out-of-band from any location without the use of agents. The BMC 118 includes hardware and software that provide a variety of features including, but not necessarily limited to, device management, monitoring, power cycling, authentication, data collection and data analytics.

The information processing system 100 comprises a platform for identifying and removing functions causing operational issues. In illustrative embodiments, the platform comprises the detection engine 117 and one or more components of the host device operating system 111, DPU 112, DPU operating system 113, BIOS 115, BIOS NVRAM 116 and/or the BMC 118. In some embodiments, the detection engine 117 is a component of the BMC 118.

During the booting of the host device 110 (e.g., a server), the DPU 112 (e.g., SmartNIC) will enumerate and expose functions such as, but not necessarily limited to, peripheral component interconnect (PCI) and/or peripheral component interconnect express (PCIe) functions to the host device operating system 111. In some embodiments, the functions are virtualized and emulated to the host device operating system 111. As used herein, a “function” can be broadly construed to refer to, for example, physical PCI and/or PCIe functions that are discovered, managed and manipulated like a PCI or PCIe device with a full configuration space. In some cases, the function may include the ability to move data into and out of a device, and may be seen as a separate device by the host device operating system 111. A “function” can be broadly construed to also refer to, for example, virtual PCI and/or PCIe functions, which can be lightweight PCI and/or PCIe functions attached to underlying physical PCI and/or PCIe functions. A virtual PCI and/or PCIe function may have a reduced configuration space because most of its settings are derived from an underlying physical PCI and/or PCIe function. A non-limiting example of a function is a “nonvolatile memory express (NVMe) over fabric target storage” function.

During alternating current (AC) power on, the host device operating system 111 and DPU operating system 113 boot simultaneously. In illustrative embodiments, exposed functions (e.g., PCIe functions) of the DPU 112 are leveraged by BIOS 115 and host device operating system 111. If any of the exposed functions are corrupted or fail to load, the DPU operating system 113 can crash or otherwise fail to operate. As a result of the DPU operating system 113 crashing or otherwise failing to operate, the host device operating system 111 can also crash or otherwise fail to operate. As a result, the host device 110 may go into a reboot loop and will not be able to boot until the issues with the problematic function(s) are resolved. Currently, there are no available techniques to identify and hot-remove problematic functions to avoid crashing of an operating system of a host device. Hot removal refers to dynamically removing a function, hardware and/or physical or virtual device from a running system without downtime.

The illustrative embodiments advantageously include the detection engine 117 that is configured to identify and hot-remove problematic functions which can cause or contribute to crashing or the failure to operate of the DPU operating system 113 and the host device operating system 111. As noted hereinabove, the detection engine 117 may be a component of the BMC 118 or a separate component operatively connected to the BMC 118. As explained in more detail herein, according to the illustrative embodiments, SupportAssist® logs, Lifecycle Controller (LC) logs, DPU operating system crash dump logs and/or host device operating system crash dump logs are collected by the BMC 118 and input to the detection engine 117 for identification of a problematic function.

The detection engine 117 sends the identified problematic function details to the BIOS NVRAM 116 or other persistent storage of the BIOS 115 using generated IPMI commands. In illustrative embodiments, the BMC 118 uses an IPMI to communicate with the BIOS 115. Using this communication channel, the generated IPMI commands are used to share the problematic function information with the BIOS NVRAM 116.

In illustrative embodiments, the identified problematic function information is stored in the BIOS NVRAM 116, which the BIOS 115 can access during a booting operation. The identified problematic function is excluded by the BIOS 115 from being configured by the host device operating system 111 during booting. As a result, the host device operating system 111 will not load the identified function during booting, thereby avoiding crashes. Advantageously, the illustrative embodiments prevent host device operating system reboot, crash or other failure issues caused by problematic functions and generate appropriate logs to notify users of the problematic functions.

The host device 110 is connected to one or more networks to communicate with external devices such as, for example, administrator or customer devices. The networks comprise at least a portion of a global computer network such as the Internet, although other types of networks can be part of the networks, including a wide area network (WAN), a local area network (LAN), a satellite network, a telephone or cable network, a cellular network, a wireless network such as a WiFi or WiMAX network, or various portions or combinations of these and other types of networks. The networks comprise combinations of multiple different types of networks each comprising processing devices configured to communicate using Internet Protocol (IP) or other related communication protocols.

In a non-limiting illustrative example, some embodiments may utilize one or more high-speed local networks in which associated processing devices communicate with one another utilizing PCIe cards of those devices, and networking protocols such as InfiniBand, Gigabit Ethernet or Fibre Channel. Numerous alternative networking arrangements are possible in a given embodiment, as will be appreciated by those skilled in the art.

The host device 110 illustratively comprises a computer, server or other type of processing device. At least a portion of the host device 110 can be implemented with virtual machines (VMs), containers, etc. The host device 110 and/or components thereof can comprise, for example, a desktop, laptop or tablet computer, server, storage device or other type of processing device. Such a device is an example of what is more generally referred to herein as a “processing device.” Some of the processing devices are also generally referred to herein as “computers.” The host device 110 in some embodiments comprises a computer associated with a particular company, organization or other enterprise.

The terms “user,” “customer,” “client” or “administrator” herein are intended to be broadly construed so as to encompass numerous arrangements of human, hardware, software or firmware entities, as well as combinations of such entities. At least a portion of the available services and functionalities provided by the host device 110 and/or components thereof in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments. Although not explicitly shown in FIG. 1, one or more input-output devices such as keyboards, displays or other types of input-output devices may be used to support one or more user interfaces to the host device 110.

The host device 110 illustratively provides compute services such as execution of one or more applications on behalf of each of one or more users associated with the host device 110. The term “user” herein is intended to be broadly construed so as to encompass numerous arrangements of human, hardware, software or firmware entities, as well as combinations of such entities.

A DPU 112 may enter into a “DPU Ready” state, which is triggered following a successful boot of the DPU. The BIOS 115 waits to receive a handshake signal from the DPU 112 indicating the DPU Ready state before continuing a host device booting process. The illustrative embodiments include a “DPU Failure” state that may be entered into before the DPU Ready state. The DPU Failure state is set when a DPU operating system 113 crashes or otherwise fails to operate due to issues with one or more DPU functions (e.g., PCIe functions). The DPU Failure state may also be set when the host device operating system 111 crashes or otherwise fails to operate due to issues with one or more DPU functions.

In response to receiving a DPU Failure state signal, the BIOS 115 pauses a booting process of the host device 110 (which can include booting of the host device operating system 111 and booting of the DPU operating system 113) until the detection engine 117 completes a problematic function analysis to identify one or more functions associated with the DPU 112 that are contributing to and/or causing a failure of booting of the DPU operating system 113. In an illustrative embodiment, the DPU 112 will not send a DPU Ready handshake signal to the BIOS 115 until the DPU Failure state is removed. The DPU Failure state may be removed following identification of the one or more DPU functions that are contributing to and/or causing the booting failure of the DPU operating system 113, and/or successful booting of the DPU operating system 113.

The BMC 118 collects operational data (e.g., crash dump log data) from the host device operating system 111 and from the DPU operating system 113, which is used by the detection engine 117 to identify problematic functions. In an illustrative embodiment, once the detection engine 117 identifies and communicates the problematic function details to the BIOS 115 (e.g., by sending the problematic function details to the BIOS NVRAM 116 to which the BIOS 115 has access), the DPU Failure state can be changed to the DPU Ready state. After which, the BIOS 115 can perform the booting process of the host device 110 without loading and/or configuring any identified problematic functions.

If problems persist with booting (e.g., additional reboots/crashes), the detection engine 117 will repeatedly perform similar processing to identify other PCIe functions that are contributing to and/or causing the booting failures for a threshold number of loops (e.g., three loops). Once the threshold is reached, if the DPU operating system 113 continues to fail, an appropriate system event log (SEL) and/or LC log will be generated indicating that DPU operating system crash recovery has failed, and the DPU operating system 113 should be reinstalled.

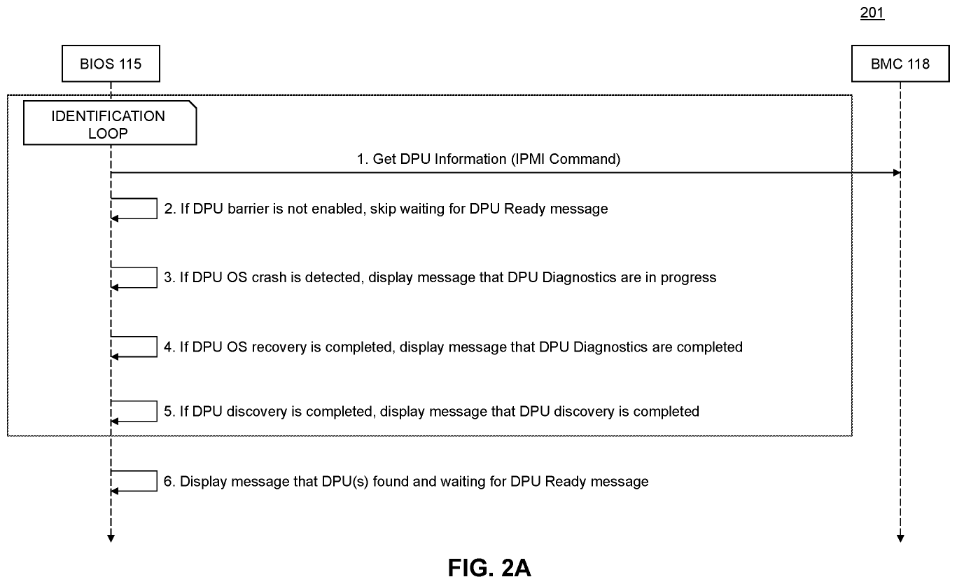

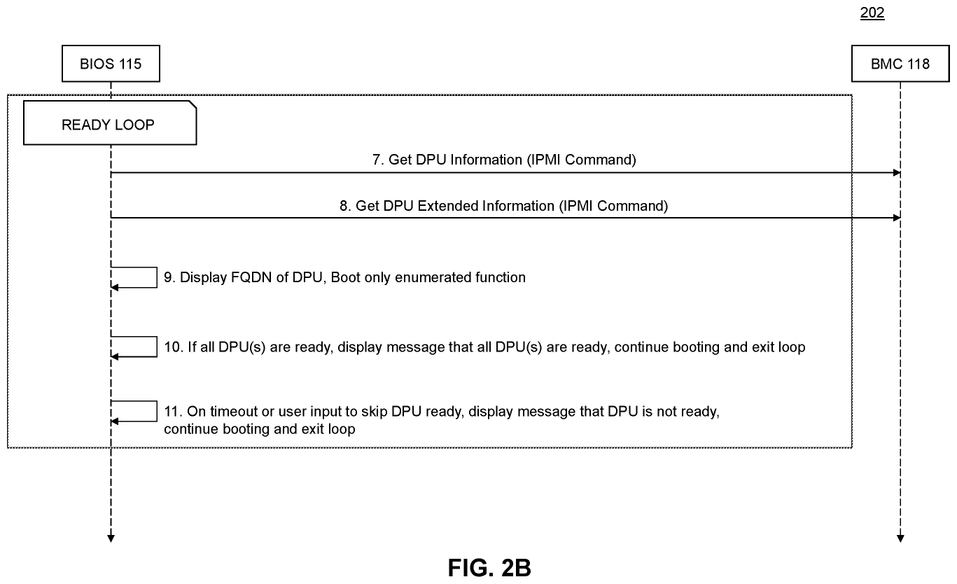

FIG. 2A depicts a function identification portion 201 of a boot sequence between the BIOS 115 and the BMC 118, and FIG. 2B depicts a continuation 202 of the boot sequence between the BIOS 115 and the BMC 118 following the function identification portion 201. In an identification loop, in step 1, the BIOS 115 sends an IPMI command to the BMC 118 to retrieve information about whether a DPU (e.g., DPU 112) is present in the host device 110. In illustrative embodiments, the BIOS 115 sends a command to check whether a DPU barrier has been enabled. For example, the IPMI command requests whether a SmartNIC barrier has been enabled before PCIe enumeration is initiated. As used herein, “PCIe enumeration” is to be broadly construed to refer to, for example, a process by which the host device 110 identifies and configures devices (e.g., DPU 112) connected to its PCIe bus. The enumeration process can include, but is not necessarily limited to, detecting the presence of PCIe devices, assigning resources to the PCIe devices (e.g., memory), and configuring the PCIe devices for use by the host device operating system 111. As a result of the enumeration process, the host device operating system 111 may be able to communicate with and manage the PCIe devices.

Referring to step 2 in FIG. 2A, if a DPU barrier is not enabled, then the BIOS 115 will conclude that a DPU is not present on the host device 110, will not wait for a DPU Ready handshake and continue a normal booting operation. However, if the BIOS 115 receives a signal from the BMC 118 that a DPU barrier has been enabled, then the BIOS 115 will wait for a DPU Ready message from the BMC 118 before continuing a normal booting operation. The DPU barrier indicates whether a DPU (e.g., DPU 112) is present in the host device 110. In an illustrative embodiment, a server performs an inventory check on whether a DPU (e.g., SmartNIC) is present in the server by issuing a command to check whether a DPU barrier has been enabled. If the DPU is present, the server loads the PCIe functions of the DPU and if not present, the server will boot normally and does not wait for a DPU Ready signal.

The BMC 118 may detect that the DPU operating system 113 crashed during the booting operation, and send a message (e.g., DPU Failure state signal) to the BIOS 115 that the crash has occurred. Referring to step 3 in FIG. 2A, if the crash is detected, the BIOS 115 may display a message to a user that DPU diagnostics are in progress and/or that a DPU operating system crash has been detected. As noted herein above, in response to receiving a DPU Failure state signal, the BIOS 115 pauses the booting process of the host device 110 until the detection engine 117 completes a problematic function analysis to identify one or more functions associated with the DPU 112 that are contributing to and/or causing a failure of booting of the DPU operating system 113. The BMC 118 collects operational data (e.g., host device and/or DPU operating system crash dump log data) from the host device operating system 111 and from the DPU operating system 113, which is used by the detection engine 117 to identify problematic functions.

In an illustrative embodiment, following identification of the one or more DPU functions that are contributing to and/or causing the booting failure of the DPU operating system 113, the DPU Failure state may be removed by, for example, the BMC 118. Referring to step 4, if DPU operating system recovery has been completed, upon receipt of a communication identifying the problematic function and/or a communication that the problematic function has been identified, the BIOS 115 may display a message to a user that DPU diagnostics have been completed. Then, referring to step 5, if DPU discovery has been completed, the BIOS 115 may display a message to a user that DPU discovery has been completed. The BIOS 115 shall enumerate other functions of the DPU 112 or other DPU(s) (e.g., SmartNIC(s)) that are not identified as problematic with, for example, slot number.

Referring to step 6, the BIOS 115 may display a message to a user that DPU(s) have been found, and that the BIOS 115 is waiting for a DPU Ready message. As noted herein above, the DPU 112 will not send a DPU Ready handshake signal to the BIOS 115 (or to the BMC 118) until the DPU Failure state is removed. The BIOS 115 and/or BMC 118 will initiate hot-removal of problematic functions (e.g., PCIe functions) and perform boot synchronization of DPU(s) to become ready. As noted herein above, once the detection engine 117 identifies and communicates the problematic function details to the BIOS 115 (e.g., by sending the problematic function details to the BIOS NVRAM 116 to which the BIOS 115 has access), the DPU Failure state can be changed to the DPU Ready state. Then, the BIOS 115 can perform a booting process of the host device 110 without loading and/or configuring any identified problematic functions, while loading and/or configuring other functions of the DPU 112 or other DPU(s) that are not identified as problematic.

Following step 6 in FIG. 2A, FIG. 2B illustrates a continuation 202 of the boot sequence between the BIOS 115 and the BMC 118 following the function identification portion 201. In a ready loop, at step 7, which is similar to step 1, the BIOS 115 sends an IPMI command to the BMC 118 to retrieve information about whether a DPU (e.g., DPU 112) is present in the host device 110. In illustrative embodiments, the IPMI command may be a command to check whether a DPU barrier has been enabled. In step 8, the BIOS 115 further sends an IPMI command to retrieve DPU extended information.

In response, referring to step 9, the BIOS 115 receives a DPU Ready handshake from the DPU 112 (e.g., via the BMC 118), which is transmitted with the fully qualified domain name (FQDN) of the DPU 112, which provides the exact location of the DPU 112 within the domain name system (DNS) by specifying the hostname, domain name and top-level domain (TLD). The DPU ready handshake is further transmitted with the identified problematic function details, and details of the functions that have not been identified as problematic. Such details may be transmitted to, for example, the BIOS NVRAM 116.

Then, referring to step 10, if all DPU(s) (e.g., DPU 112) are ready, the BIOS 115 displays a message that all DPU(s) are ready, continues the booting operation of the host device 110 and exits the ready loop. As noted herein above, the booting process of the host device 110 is performed without loading and/or configuring any identified problematic functions. Functions of the DPU(s) that were not identified as problematic are loaded and/or configured during the booting process. Referring to step 11, if problems persist with booting (e.g., additional reboots/crashes), the detection engine 117 will repeatedly perform similar processing to identify other DPU functions that are contributing to and/or causing the booting failures for a threshold number of loops (e.g., three loops). If the DPU operating system 113 continues to fail and the threshold is reached or a user enters a command to skip booting of the DPU operating system 113, the BIOS 115 displays a message that the DPU 112 is not ready, continues booting without configuring the DPU 112 or the DPU operating system 113, and exits the ready loop. As noted herein above, an appropriate SEL and/or LC log will be generated indicating that DPU operating system crash recovery has failed, and the DPU operating system 113 should be reinstalled.

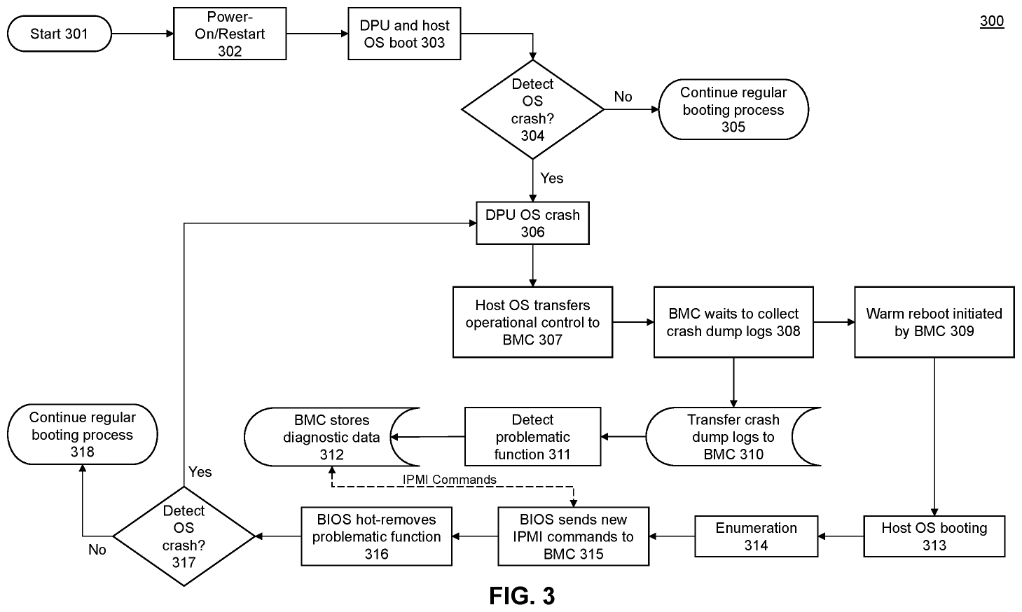

Referring to the operational flow 300 in FIG. 3, following a start of the flow at step 301, the host device 110 is powered on and/or restarted at step 302, and at step 303, the BIOS 115 and DPU operating system 113 start booting simultaneously. If a DPU operating system crash is detected at step 304, the operational flow 300 proceeds to step 306, indicating that a DPU operating system crash has occurred. If a DPU operating system crash is not detected at step 304, the operational flow 300 proceeds to step 305, where a regular booting process continues. The BIOS 115 waits for a DPU Ready signal to continue the regular booting process. If a DPU operating system crash occurs, a DPU and/or its operating system (e.g., DPU 112, DPU operating system 113) enter into a DPU operating system failure state. At this point, upon receipt of notification of the DPU operating system failure state, the BIOS 115 pauses execution of the host device operating system and DPU operating system booting operation and, referring to step 307, the host device operating system 111 (e.g., BIOS 115) transfers operational control to the BMC 118 (e.g., iDRAC).

At step 308, the BMC 118 waits to collect data corresponding to the crash (or other failure of the DPU operating system 113) in the form of, for example, host device and/or DPU operating system crash dump logs. At step 310, the failure data (e.g., crash dump logs) is transferred to the BMC 118. Then, at step 311 the detection engine 117 (which may be a component of the BMC 118), identifies the function(s) (e.g., PCIe function(s)) of the DPU 112 that are causing and/or contributing to the failure/crashing of the DPU operating system 113. At step 312, the BMC 118 stores diagnostic data including problematic function details in its internal storage, which can be accessed (e.g., pulled) by the BIOS 115 using IPMI commands and stored in the BIOS NVRAM 116. Additionally, or alternatively, the BMC 118 pushes the diagnostic data including problematic function details to the BIOS NVRAM 116 which is accessible by the BIOS 115.

Referring to step 309, following the identification of the problematic functions, the BMC 118 initiates a warm or soft reboot of the host device operating system 111, where the host device operating system 111 restarts while the power for the host device 110 remains on. The warm reboot closes the running programs on the host device 110 and reinitiates the boot sequence automatically. At step 313, the boot sequence for the host device operating system 111 is re-initiated, and at step 314 BIOS and PCIe enumeration is performed. As part of the enumeration process, at step 315, the BIOS 115 sends generated IPMI commands to the BMC 118 to pull the diagnostic data including problematic function details, which is stored in the BIOS NVRAM 116 following receipt of the diagnostic data. As noted above, the BMC 118 can push the diagnostic data to the BIOS NVRAM 116 which is accessible by the BIOS 115 as part of the enumeration process. At step 316, the BIOS 115 hot-removes the problematic functions (e.g., PCIe functions) identified in the diagnostic data. As a result, the BIOS 115 excludes (e.g., does not load or configure) those functions during the booting operation. The BMC 118 generates appropriate logs for the functions which are excluded.

If a DPU operating system crash is not detected at step 317, the operational flow 300 proceeds to step 318, where the regular booting process continues. If there are no subsequent issues, the host device operating system 111 and DPU operating system 113 will successfully load. If a DPU operating system crash is detected at step 317, the operational flow 300 loops back to step 306, indicating that a DPU operating system crash has occurred. In illustrative embodiments, if issues persist, the operational flow 300 from steps 306 to 316, including the identification of problematic functions, will continue for a threshold number of loops (e.g., three loops) before the process ends with the generation of appropriate logs indicating that DPU operating system failure has failed, and the DPU operating system 113 should be reinstalled.

According to one or more embodiments, BIOS NVRAM 116, memories and other data repositories or databases referred to herein can be configured according to a relational database management system (RDBMS) (e.g., PostgreSQL). In some embodiments, BIOS NVRAM 116, memories and other data repositories or databases referred to herein are implemented using one or more storage systems or devices associated with the platform for identifying and removing functions causing operational issues. In some embodiments, one or more of the storage systems utilized to implement databases, memories and other data repositories referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

The platform for identifying and removing functions causing operational issues comprising the detection engine 117 and one or more components of the host device operating system 111, DPU 112, DPU operating system 113, BIOS 115, BIOS NVRAM 116 and/or the BMC 118 is assumed to be implemented using at least one processing device. Each such processing device generally comprises at least one processor and an associated memory, and implements one or more functional modules for controlling certain features of the platform for identifying and removing functions causing operational issues.

At least portions of the platform for identifying and removing functions causing operational issues comprising the detection engine 117 and one or more components of the host device operating system 111, DPU 112, DPU operating system 113, BIOS 115, BIOS NVRAM 116 and/or the BMC 118 and the elements thereof may be implemented at least in part in the form of software that is stored in memory and executed by a processor. The platform for identifying and removing functions causing operational issues and the elements thereof comprise further hardware and software required for running the platform for identifying and removing functions causing operational issues, including, GPU hardware, virtualization infrastructure software and hardware, Docker containers, networking software and hardware, and cloud infrastructure software and hardware.

It is assumed that the platform for identifying and removing functions causing operational issues and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the platform for identifying and removing functions causing operational issues comprising the detection engine 117 and one or more components of the host device operating system 111, DPU 112, DPU operating system 113, BIOS 115, BIOS NVRAM 116 and/or the BMC 118, and the elements thereof can be implemented in the form of one or more LXCs running on one or more VMs. Other arrangements of one or more processing devices of a processing platform can be used to implement the platform for identifying and removing functions causing operational issues. Other portions of the system 100 can similarly be implemented using one or more processing devices of at least one processing platform.

It is to be appreciated that these and other features of illustrative embodiments are presented by way of example only, and should not be construed as limiting in any way. Accordingly, different numbers, types and arrangements of system elements such as the host device operating system 111, DPU 112, DPU operating system 113, BIOS 115, BIOS NVRAM 116, detection engine 117, the BMC 118 and other elements of the platform for identifying and removing functions causing operational issues, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the platform for identifying and removing functions causing operational issues can be offered to cloud infrastructure customers or other users as part of FaaS, CaaS and/or PaaS offerings.

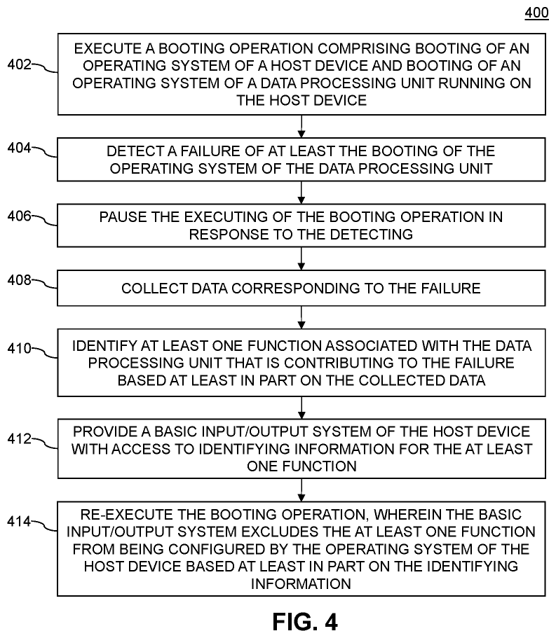

The operation of the information processing system 100 will now be described in further detail with reference to the flow diagram of FIG. 4. With reference to FIG. 4, a process 400 for identifying and removing functions causing operational issues as shown includes steps 402 through 414, and is suitable for use in the information processing system 100 but is more generally applicable to other types of information processing systems or architectures comprising a platform for identifying and removing functions causing operational issues.

In step 402, a booting operation is executed. The booting operation comprises booting of an operating system of a host device and booting of an operating system of a DPU running on the host device. The operating system of the DPU is different from an operating system of the host device. The DPU may comprise a NIC (e.g., SmartNIC).

In step 404, a failure of at least the booting of the operating system of the DPU is detected. In step 406, the executing of the booting operation is paused in response to the detecting. In step 408, data corresponding to the failure is collected. The collecting of the data corresponding to the failure can be performed by a BMC. In step 410, at least one function associated with the DPU that is contributing to the failure is identified based at least in part on the collected data. The at least one function may comprise a PCIe function.

In step 412, a BIOS of the host device is provided with access to identifying information for the at least one function. In step 414, the booting operation is re-executed, wherein the BIOS excludes the at least one function from being configured by the operating system of the host device based at least in part on the identifying information. The identifying information for the at least one function may comprise a bus identifier for the at least one function (e.g., PCIe function bus ID), a name of the at least one function (e.g., PCIe name) and a driver version associated with the at least one function (e.g., PCIe driver version).

In an illustrative embodiment, the failure comprises a crash of the operating system of the DPU and the data corresponding to the failure comprises one or more crash dump logs.

According to one or more embodiments, the identifying information for the at least one function is stored in a non-volatile memory of the BIOS. One or more IPMI commands are generated to cause transmission of the identifying information for the at least one function to the non-volatile memory of the BIOS.

In illustrative embodiments, a DPU failure state signal is generated in response to the failure of the booting of the operating system of the DPU, and the DPU failure state signal is sent to the BIOS. The pausing of the executing of the booting operation can be performed in response to receipt of the DPU failure state signal by the BIOS. A DPU ready state signal is generated following the identifying of the at least one function, and the DPU ready state signal is sent to the BIOS. The re-executing of the booting operation can be performed in response to receipt of the DPU ready state signal by the BIOS. One or more logs corresponding to the re-executing of the booting operation and to excluding the at least one function from being configured by the operating system of the host device can be generated.

It is to be appreciated that the FIG. 4 process and other features and functionality described above can be adapted for use with other types of information systems configured to identify and remove functions causing operational issues in a booting management platform or other type of platform.

The particular processing operations and other system functionality described in conjunction with the flow diagram of FIG. 4 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 4 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a platform for identifying and removing functions causing operational issues as disclosed herein can provide a number of significant advantages relative to conventional arrangements. For example, the embodiments provide a technical solution including a framework that identifies the problematic functions (e.g., PCIe functions) using a host device BMC and hot-removes those functions during a booting operation to result in successful booting of a host device operating system and a DPU operating system. The problematic function information advantageously accessed by the host device BIOS to perform hot-removal during the host device booting. In one or more embodiments, the problematic function information is stored in a BIOS non-volatile memory.

The embodiments advantageously provide techniques to avoid configuration of identified problematic PCIe functions during a booting sequence, thereby containing host operating system reboot/crash issues due to the problematic PCIe functions. Unlike conventional approaches, the embodiments utilize introduce a DPU failure state during which a BMC collects failure/crash data to identify problematic functions. The problematic function details are advantageously shared with a host device BIOS so that the host device BIOS can utilize the problematic function details to remove the issue-causing functions from a booting operation.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the platform for identifying and removing functions causing operational issues or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a data packet conversion platform in illustrative embodiments. These and other cloud-based systems in illustrative embodiments can include object stores.

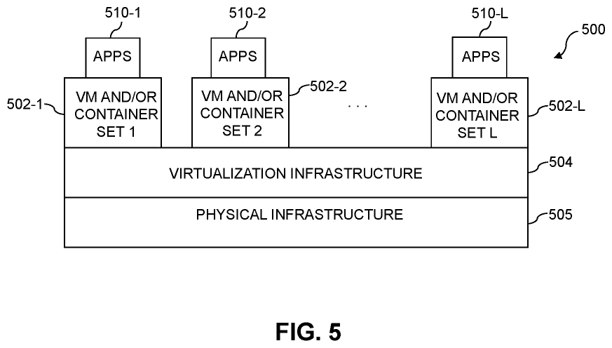

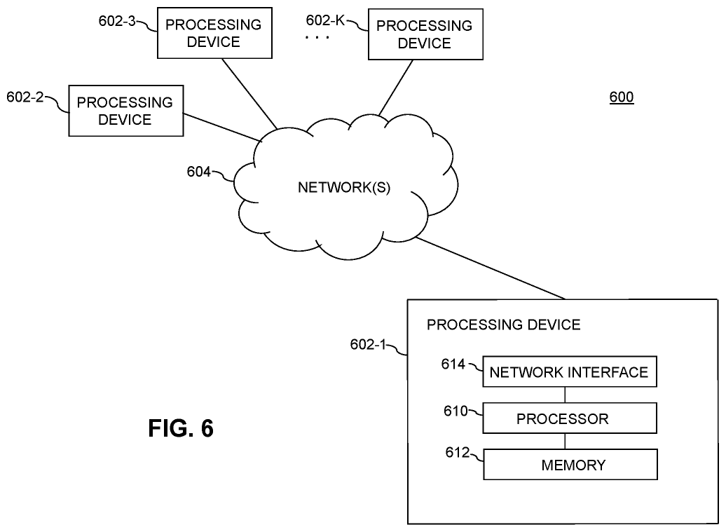

Illustrative embodiments of processing platforms will now be described in greater detail with reference to FIGS. 5 and 6. Although described in the context of information processing system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. A hypervisor platform may be used to implement a hypervisor within the virtualization infrastructure 504, where the hypervisor platform has an associated virtual infrastructure management system. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612. The processor 610 may comprise a microprocessor, a microcontroller, an application-specific integrated circuit (ASIC), a field-programmable gate array (FPGA), a CPU, a GPU, a TPU, a VPU or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the platform for identifying and removing functions causing operational issues as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and configuration management platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
executing a booting operation comprising booting of an operating system of a host device and booting of an operating system of a data processing unit running on the host device;
detecting a failure of at least the booting of the operating system of the data processing unit;
pausing the executing of the booting operation in response to the detecting;
collecting data corresponding to the failure;
identifying at least one function associated with the data processing unit that is contributing to the failure based at least in part on the collected data;
providing a basic input/output system of the host device with access to identifying information for the at least one function; and
re-executing the booting operation, wherein the basic input/output system excludes the at least one function from being configured by the operating system of the host device based at least in part on the identifying information;
wherein the steps of the method are executed by at least one processing device operatively coupled to a memory.

2. The method of claim 1 wherein the operating system of the data processing unit is different from an operating system of the host device.

3. The method of claim 1 wherein the data processing unit comprises a network interface controller.

4. The method of claim 1 wherein the at least one function comprises a peripheral component interconnect express (PCIe) function.

5. The method of claim 1 wherein the failure comprises a crash of the operating system of the data processing unit and the data corresponding to the failure comprises one or more crash dump logs.

6. The method of claim 1 wherein the identifying information for the at least one function comprises at least one of a bus identifier for the at least one function, a name of the at least one function and a driver version associated with the at least one function.

7. The method of claim 1 wherein:
the identifying information for the at least one function is stored in a non-volatile memory of the basic input/output system; and
the method further comprises generating one or more intelligent platform management interface commands to cause transmission of the identifying information for the at least one function to the non-volatile memory of the basic input/output system.

8. The method of claim 1 wherein the collecting of the data corresponding to the failure is performed by a baseboard management controller.

9. The method of claim 1 further comprising:
generating a data processing unit failure state signal in response to the failure of the booting of the operating system of the data processing unit; and
sending the data processing unit failure state signal to the basic input/output system.

10. The method of claim 9 wherein the pausing of the executing of the booting operation is performed in response to receipt of the data processing unit failure state signal by the basic input/output system.

11. The method of claim 9 further comprising:
generating a data processing unit ready state signal following the identifying of the at least one function; and
sending the data processing unit ready state signal to the basic input/output system.

12. The method of claim 11 wherein the re-executing of the booting operation is performed in response to receipt of the data processing unit ready state signal by the basic input/output system.

13. The method of claim 1 further comprising generating one or more logs corresponding to the re-executing of the booting operation and to excluding the at least one function from being configured by the operating system of the host device.

14. An apparatus comprising:
a processing device operatively coupled to a memory and configured:
to execute a booting operation comprising booting of an operating system of a host device and booting of an operating system of a data processing unit running on the host device;
to detect a failure of at least the booting of the operating system of the data processing unit;
to pause the executing of the booting operation in response to the detecting;
to collect data corresponding to the failure;
to identify at least one function associated with the data processing unit that is contributing to the failure based at least in part on the collected data;
to provide a basic input/output system of the host device with access to identifying information for the at least one function; and
to re-execute the booting operation, wherein the basic input/output system excludes the at least one function from being configured by the operating system of the host device based at least in part on the identifying information.

15. The apparatus of claim 14 wherein the processing device is further configured:
to generate a data processing unit failure state signal in response to the failure of the booting of the operating system of the data processing unit; and
to send the data processing unit failure state signal to the basic input/output system.

16. The apparatus of claim 15 wherein the pausing of the executing of the booting operation is performed in response to receipt of the data processing unit failure state signal by the basic input/output system.

17. The apparatus of claim 15 wherein the processing device is further configured:
to generate a data processing unit ready state signal following the identifying of the at least one function; and
to send the data processing unit ready state signal to the basic input/output system.

18. An article of manufacture comprising a non-transitory processor-readable storage medium having stored therein program code of one or more software programs, wherein the program code when executed by at least one processing device causes said at least one processing device to perform the steps of:
executing a booting operation comprising booting of an operating system of a host device and booting of an operating system of a data processing unit running on the host device;
detecting a failure of at least the booting of the operating system of the data processing unit;
pausing the executing of the booting operation in response to the detecting;
collecting data corresponding to the failure;
identifying at least one function associated with the data processing unit that is contributing to the failure based at least in part on the collected data;
providing a basic input/output system of the host device with access to identifying information for the at least one function; and
re-executing the booting operation, wherein the basic input/output system excludes the at least one function from being configured by the operating system of the host device based at least in part on the identifying information.

19. The article of manufacture of claim 18 wherein the program code further causes said at least one processing device to perform the steps of:
generating a data processing unit failure state signal in response to the failure of the booting of the operating system of the data processing unit; and
sending the data processing unit failure state signal to the basic input/output system.

20. The article of manufacture of claim 19 wherein the pausing of the executing of the booting operation is performed in response to receipt of the data processing unit failure state signal by the basic input/output system.
